(19) United States
(12) Patent Application Publication
(10) Pub. No.: US 2008/0094585 A1
(43) Pub. Date: Apr. 24, 2008

(54) Projector

(75) Inventors: Wilhelmus Joseph Rosendaal, Eindhoven (NL); Johannes Bree, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,085

(22) PCT Filed: May 13, 2005
(86) PCT No.: PCT/IB05/51573

§ 371 Date: Nov. 14, 2006

(30) Foreign Application Priority Data
May 18, 2004 (EP) 04102183.3

(51) Int. Cl. G03B 21/28

(52) U.S. Cl. 353/98

(57) ABSTRACT

A projector includes a cabinet (10) having a light source (12) for generating a light beam; a mirror (40) for reflecting the light beam; and a holding means (30) for holding the mirror, which is movably coupled to the cabinet. The mirror is movable relative to the holding means.

The invention relates to a projector, which comprises a cabinet having a light source for generating a light beam, a mirror for reflecting the light beam, and a holding means for holding the mirror, which is movably coupled to the cabinet.

An embodiment of a projector of the kind described in the opening paragraph is known from U.S. Pat. No. 6,190,015B1. The known projector has a cabinet, a holding means being movable relative to the cabinet, and a mirror fixed on the holding means. The cabinet has a light source for generating a light beam. The light beam leaves the cabinet, reflects on the mirror, and transfers toward a projection screen. By adapting the position of the mirror, the direction of the light beam can be controlled. It's important that for relevant position of the mirror, the light beam is appropriately reflected. So, the mirror must be relatively big for reflecting the light beam toward the projection screen. However, if the mirror is too big, it will occupy too much space, and cause much inconvenience.

It is an object of the invention to provide a projector of the kind described in the opening paragraph, which has a mirror with a relatively small size.

This object of the invention is achieved in that the projector has a mirror, which is movable relative to the holding means. The mirror of the invention is relatively small and movable relative to the holding means. When the projector is not operating, the holding means and the mirror are covering the cabinet, and don't exceed the cabinet and hence save much space. When the projector is operating, the holding means moves away from the cabinet, and the mirror can move out from the holding means for adjusting the reflection spot relative to the holding means to reflect the light beam to the projection screen. The result is that the mirror is aligned with the light beam for different positions of the holding means.

It seems that there would have been another solution for the problem: just making the mirror smaller. But, in fact it is not a real solution, because it would cause another problem. If the mirror is too small, it can't reflect the light beam to the projection screen for each position of the holding means.

In an embodiment of the projector according to the invention, the holding means is a cover or a part of cover. The advantage is that the cover, when it is closed, can protect the mirror and some components in the cabinet.

In an embodiment of the projector according to the invention, the mirror is slidable in the holding means. Preferably, the holding means has a slot for receiving an edge of the mirror therein. The advantage is that the slot is a relative simple structure.

In another embodiment of the projector according to the invention, the mirror is shiftable relative to the holding means. Typically, the shiftable mirror is driven by means of a number of arms. So, the holding means has a number of arms for coupling the mirror to the holding means. The advantage is that such a structure is very simple.

In an embodiment of the projector according to the invention, the projector has a driving means for driving the holding means relatively to the cabinet. It's a convenient structure.

In an embodiment of the projector according to the invention, the projector has a coupling means for moving the mirror relative to the holding means, when the holding means are moved relative to the cabinet. It can automatically cause the mirror to move relatively to the holding means. One movement results into a second movement.

These and other aspects of the projector, according to the invention will become apparent from and will be elucidated with respect to the implementations and embodiments described hereinafter and with reference to the accompanying drawings, wherein:

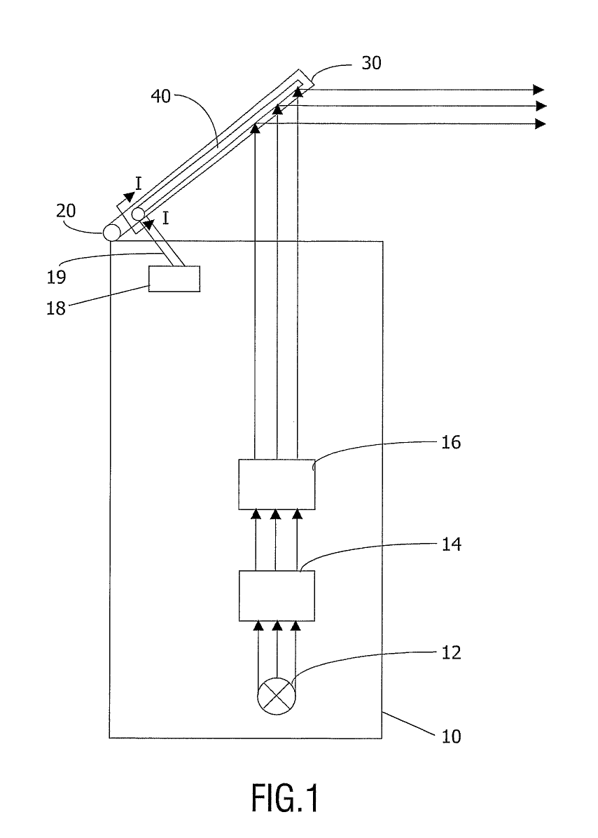

FIG. 1 schematically shows an embodiment of the projector;

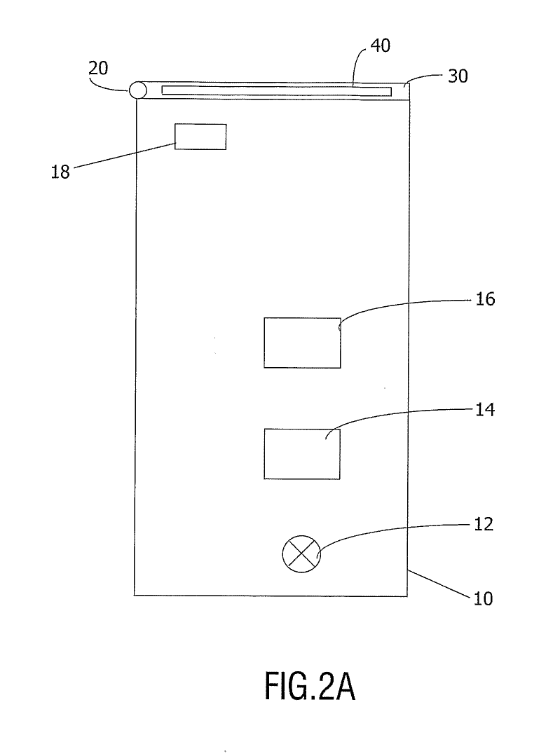

FIG. 2A-2C, schematically show an embodiment of the projector, of which the mirror is located in three different positions;

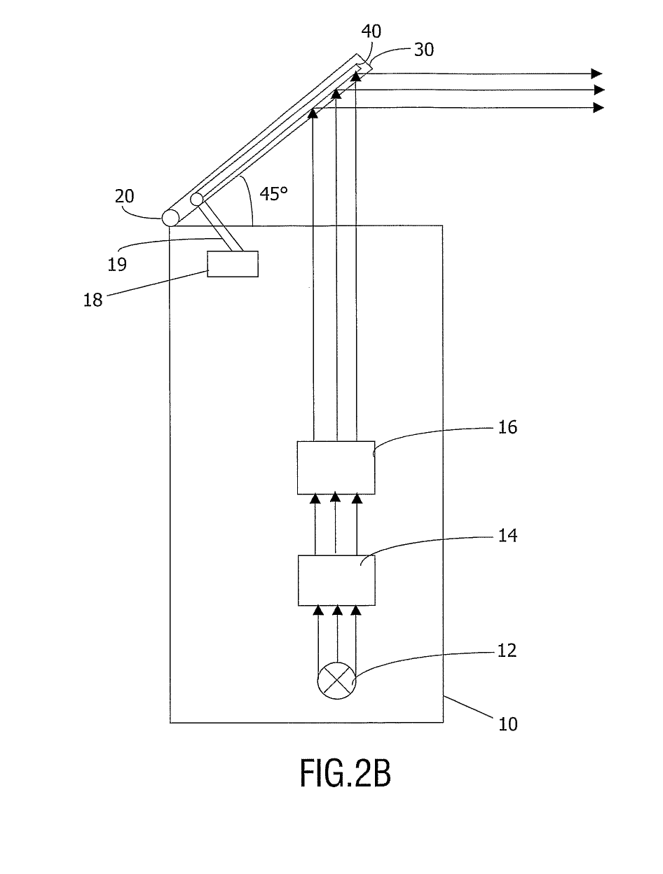

FIG. 3 schematically shows a cross-section taken on the line I-I of FIG. 1;

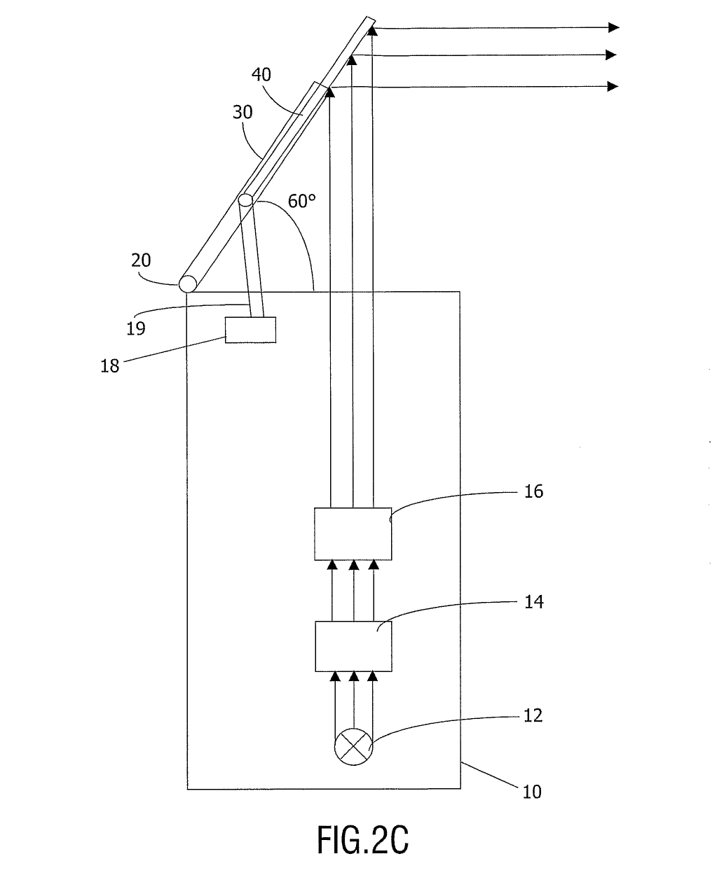

FIG. 4 schematically shows a part of another embodiment of the projector; and

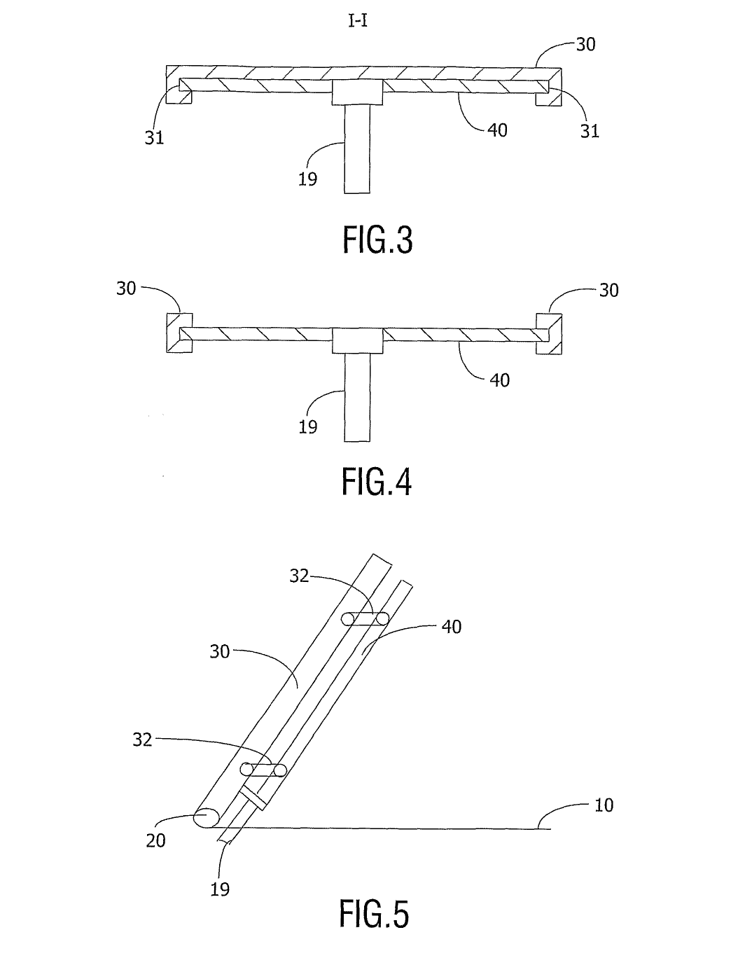

FIG. 5 schematically shows a part of a further embodiment of the projector.

Same reference numerals are used to denote similar parts throughout the figures.

FIG. 1 schematically shows an embodiment of the projector according to the invention. The projector comprises a cabinet 10, a holding means 30, and a mirror 40 received in the holding means 30. The projector further comprises a hinge 20 for coupling the cabinet 10 and the holding means 30.

The cabinet comprises a light source 12, a luminance modulation unit 14, an optical means 16, a driving device 18, and a coupling device 19. The light source 12 is arranged to generate a light beam. The luminance modulation unit 14 is arranged to modulate the light beam. The optical means 16 is a transparent optical device arranged to converge or diverge the transmitted light beam from the luminance modulation unit 14 and to form images. The driving device 18 is used to give power to cause movement. The coupling device 19 is driven to move by the driving device 18.

The holding means 30 is coupled to the cabinet by the hinge 20, which is coupled by the coupling device 19 to move relative to the cabinet 10.

The mirror 40 is movably received in the holding means 30, and coupled with the coupling means. The mirror 40 is used to reflect the light beam, which has left the optical means 16 of the cabinet 10.

When the projector is in use, the light source 12 is arranged to generate the light beam, and then the light beam will subsequently go through the luminance modulation unit 14 and the optical means 16 and come out of the cabinet 10. The driving device 18 is arranged to cause the coupling device 19 to move, and the coupling device 19 is arranged to couple the holding means 30 and the mirror 40 relative to the cabinet 10 with the mirror 40 relative to the holding means 30. So, if the light beam comes out of the cabinet 10, the mirror 40 will adjust its position to reflect the light beam to a projection screen (not shown).

In FIG. 2A, the projector is not in use. So the holding means 30 is covering the cabinet for protecting optical means 16 in the cabinet 10 and the mirror 40.

In FIG. 2B, the projector is in use. The mirror 40 has a 45° angle with the top surface of the cabinet 10. If the light beam comes out of the cabinet 10 as depicted in FIG. 2B, the driving device 18 will drive the coupling device 19 to move, and the coupling device 19 will couple the holding means 30 and the mirror 40 to relatively move for reflecting the light beam to the projection screen as depicted in FIG. 2B.

In FIG. 2C, the projector is in use. The mirror 40 has a 60° angle with the top surface of the cabinet 10. If the light beam comes out of the cabinet 10 as depicted in FIG. 2C, the driving device 18 will drive the coupling device 19 to move, and the coupling device 19 will couple the holding means 30 and the mirror 40 to relatively move for reflecting the light beam to the projection screen. As depicted in FIG. 2C, the mirror 40 is coupled out of the holding means 30 for reflecting the light beam.

In this embodiment, the mirror and holding means are relatively small, don't exceed out of the cabinet. So, the holding means and the mirror don't occupy too much space. On the other hand, when the holding means is moving relative to the top surface of the cabinet 10, the mirror can move relative to the holding means for adjusting the reflection spot relative to the holding means to reflect the light beam to the projection screen. The result is that the mirror is aligned with the light beam for different positions of the holding means

FIG. 3 schematically shows a cross-section taken on the line I-I of FIG. 1. The holding means 30 comprises two slots 31 for slideably holding two edges of the mirror 40. The driving device 18 is used to drive the coupling device 19 to move. The coupling device 19 is movably coupled with the holding means with contacting with holding means and the mirror.

FIG. 4 schematically shows a part of another embodiment of the projector. The embodiment is similar to the first embodiment as described in connection with FIG. 1. In this embodiment, the projector has two holding means 30, and they are not mutually connected. Each holding means 30 comprises a slot 31 for holding one edge of the mirror 40 therein.

FIG. 5 schematically shows a part of a further embodiment of the projector. This embodiment is similar to the first embodiment as described in connection with FIG. 1. The difference is that the holding means 30 doesn't have any slot to receive two edges of the mirror 40. This embodiment comprises four arms 32, of which two are no depicted, to movably couple the mirror with the holding means 30. So the mirror 40 is shiftable coupled with the holding means 30.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware. The usage of the words first, second and third, etcetera do not indicate any ordering. These words are to be interpreted as names.

1. A projector comprising:
a cabinet having a light source for generating a light beam;
a mirror for reflecting the light beam; and
a holding means for holding the mirror, which is movably coupled to the cabinet, characterized in that the mirror is movable relative to the holding means.

2. A projector as claimed in claims 1, wherein the holding means is a cover or a part of a cover.

3. A projector as claimed in claim 1, wherein the mirror is slidable in the holding means.

4. A projector as claimed in claim 3, wherein the holding means has a slot for receiving an edge of the mirror therein.

5. A projector as claimed in claim 1, wherein the mirror is shiftable relative to the holding means.

6. A projector as claimed in claim 1, wherein the holding means comprises a number of arms for coupling the mirror to the holding means.

7. A projector as claimed in claim 1, wherein the projector has a driving means for driving the holding means relative to the cabinet.

8. A projector as claimed in claim 1, wherein the projector has a coupling means for moving the mirror relative to the holding means, when the holding means are moved relative to the cabinet.
